(19) United States
(12) Patent Application Publication
(10) Pub. No.: US 2006/0190285 A1
(43) Pub. Date: Aug. 24, 2006

(54) Method and apparatus for storage and distribution of real estate related data

(76) Inventors: Trevor M. Harris, Morgantown, WV (US); David V. Baker, Morgantown, WV (US); Scot Thrane Refsland, Kirkland, WA (US)

Correspondence Address: Schwegman, Lundberg, Woessner & Kluth, P.A., P.O. Box 2938, Minneapolis, MN, 55402, US

(21) Appl. No.: 11/267,042

(22) Filed: Nov. 4, 2005

Related U.S. Application Data
(60) Provisional application No. 60/625,734, filed on Nov. 4, 2004.

(51) Int. Cl. G06Q 99/00

(52) U.S. Cl. 705/1

(57) ABSTRACT

Systems, methods, and software for storage and distribution of real estate related data. Some embodiments include a database of data representing three-dimensional topographic views of geographic areas and a computer system adapted to present a topographic view of a geographic area based on a query by a user for information related to a listing of a property for sale or lease. In some embodiments, properties for sale or lease are plotted and identified within a three-dimensional topographic view providing the searcher a neighborhood view of the area of interest. Users can move around the three-dimensional topographic view as if they are flying overhead.

### CROSS-REFERENCE TO RELATED APPLICATION

The present application claims priority to U.S. Provisional Application Ser. No. 60/625,734, filed Nov. 4, 2004, which is incorporated herein by reference in its entirety.

### TECHNICAL FIELD

The inventive subject matter relates generally to information and communication systems, and more particularly to methods, apparatuses, and software for storage and distribution of real estate related data.

### BACKGROUND

Real estate agent tools for finding and marketing available properties are generally text based and include minimal photos provided in a linear result list sorted by price. To access more information about a property, the agent, buyer, or other person performing a search must ‘drill down’ through a series of web pages, clicking several times, spawning new web pages for viewing maps, school district, tax, and other information.

### DESCRIPTION OF THE DRAWINGS

FIG. 1 illustrates example embodiments of the present subject matter.

FIG. 2 illustrates example software application interfaces.

FIG. 3 is an interface screen view displaying an example 3D detail of a landscape of a selected real estate property.

FIG. 4 illustrates one example of a 3D landscape display 400 for multiple selected properties.

FIG. 5 is a view illustrating generally one example of a web-based geographic map display and corresponding hand-held GPS locator.

FIG. 6 is an interface screen view illustrating generally one example of category tools.

FIG. 7 is an interface screen view illustrating generally one example of filtering tools.

FIG. 8 is an interface screen view illustrating generally one example of spatial location software tools.

FIG. 9 is an interface screen view illustrating an example of real estate property information obtained from a real estate listing service.

FIG. 10 is an interface screen view illustrating an example of a keyword search tool.

FIG. 11 illustrates a screen view of a keyword search result in view of an address.

FIG. 12 illustrates an example 3D detail of a landscape view for multiple user-selected school properties.

FIG. 13 is an interface screen view illustrating an example 3D detail of a landscape according to user-specified criteria.

FIG. 14 is an interface screen view illustrating an example 3D detail of a landscape and displayed distances between user-selected locations.

FIG. 15 illustrates an example embodiment of a system on which the subject matter hereof can be practiced.

FIG. 16 is schematic illustrating an example embodiment of a GeoPoints network architecture.

FIG. 17 is schematic illustrating a Client Connectivity Manager architecture.

FIG. 18 is schematic illustrating an example embodiment of a GeoPoints system architecture.

FIG. 19 is schematic illustrating an example client architecture.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions encoded in a computer readable media. Further, such functions correspond to modules, which are software, hardware, firmware, or any combination thereof. Multiple functions are performed in one or more modules as desired, and the embodiments described are merely examples. The software is executed on a digital signal processor, application-specific integrated circuit, microprocessor, or other type of processor operating on a system, such as a personal computer, server, a router, or other device capable of processing data including network interconnection devices.

Some embodiments are implement the functions in two or more specific interconnected hardware modules or devices with related control and data signals communicated between and through the modules, or as portions of an application-specific integrated circuit. Thus, the exemplary process flow is applicable to software, firmware, and hardware implementations.

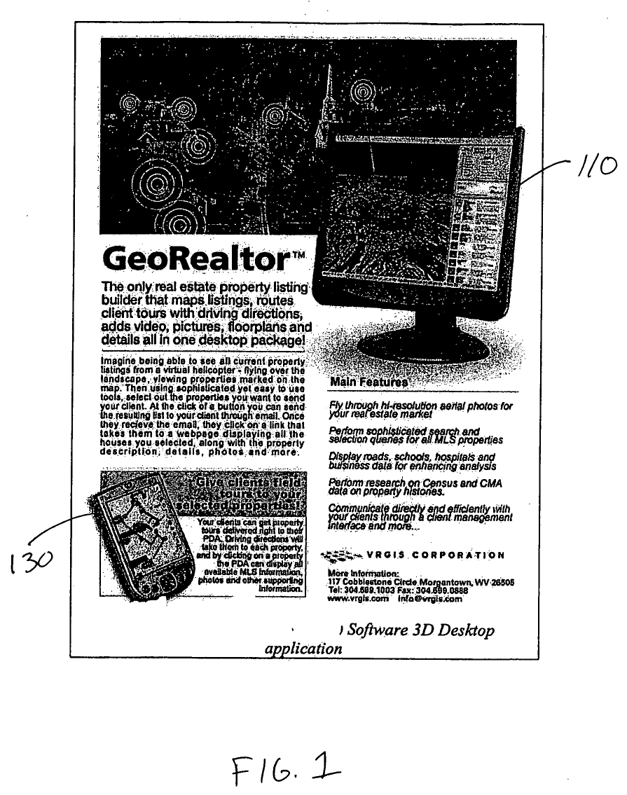

FIG. 1 illustrates example embodiments of the present subject matter. For example, FIG. 1 illustrates various embodiments of that include real estate related systems and software that facilitate retrieval and display of information related to properties for sale. This information can include properties for sale, pictures, location, maps, tax data, neighborhood and school information, voting data, census data, title or deed data, and virtually any other data related to real estate. These and other embodiments can operate on a personal computer, such as a desktop or laptop personal computer, on a mobile device, such as a personal digital assistant 130, a mobile telephone, other mobile computing device, or virtually any other computing device capable of receiving input, processing and retrieving data, and generating output. Such embodiments utilize a tight integration of Virtual Reality (VR), Geographic Information Systems (GIS), Location-Based Services (LBS) and real-time datasets.

For example, some embodiments combine aerial photography 110 into a game-style engine that enables a user to fly around a 3D environment and view high-resolution images and terrain definitions. Some such embodiments include a search engine that directly queries one or more real estate listing service databases, such as Regional Multi-Listing Service (“RMLS” or “MLS”) databases to generate a real time display of available properties integrated within the 3D environment. When a user types in a search query, such as a query based on zip code, property type, price range, or other real estate feature, location results are displayed in a listing, populated automatically into a 3D map terrain display, or both. In some embodiments, corresponding property photographs are retrieved from an MLS database and are displayed directly over the property on a 3D map terrain. This display can also include the pictured property's postal address or other data associated with or otherwise related to the property.

Embodiments including the 3D map terrain quickly provide the user with a spatial sense of available property. Some embodiments also display items such as roads, schools, hospitals, fire stations, shopping, parks and open space, public transit, and other items displayable on a map. This allows the searcher to visualize the available property in relation to these other items.

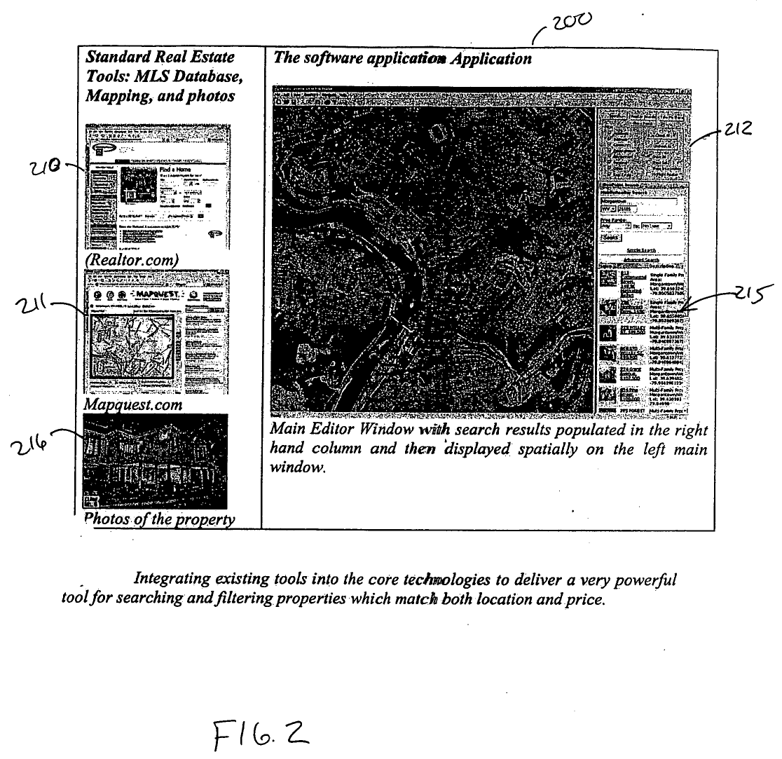

FIG. 2 illustrates example software application interfaces 200. These interfaces include standard real estate and mapping tools and a terrain visualization application 212 according to one embodiment of the present subject matter. In one embodiment, the terrain visualization application 212 uses one or more industry standard tools, including real estate listing systems such as Realtor.com 210 for property searching, Mapquest.com 211 for property mapping. These tools are integrated with a terrain visualization application 212, which provides a “virtual helicopter” type view. This provides a real estate agent, or other user, with a tool to rapidly identify, locate, and filter properties according to user-selected criteria, visualization, and other user preferences.

Once the user selects a geographic area with suitable properties, further detail about the area can be obtained by moving closer, or zooming in, to the desired location. In some embodiments, further detail can also be obtained by selecting points of interest, such as with a computer mouse or other suitable device. In some embodiments, the right-hand side of the display 200 adapts upon area or property selection to provide a more detailed listing of available properties 215, while the left-hand side can display an image of a selected property 216.

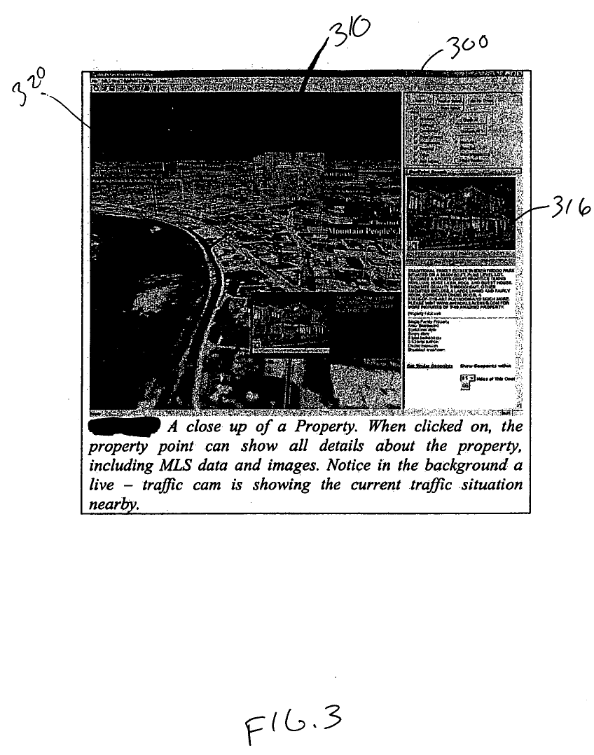

FIG. 3 is an interface screen 300 view displaying an example 3D landscape detail of a selected real estate property and neighborhood GeoPoints.

A GeoPoint models a point on the earth. In general, each GeoPoint is spatially recorded based on an eight degrees of freedom (“8DOF”) (latitude, longitude, altitude, pitch, roll, yaw, direction, speed) representation and this positional accuracy enables GeoPoints to be differentiated and displayed in 3D coordinate space. However, other embodiments include fewer or greater degrees of freedom representations. Some GeoPoints broadcast, or otherwise make available upon request, via wireless and wired network technology information about the GeoPoint. For example, a GeoPoint at a neighborhood coffee shop can provide information such as a menu, location, schedule of events, via photos, audio, video, text, or other information via a digitally transmitted medium. Further information regarding GeoPoint technology is provided below under heading “GeoPoint System Architecture.”

Selected real estate properties and neighborhood GeoPoints are not limited to real estate properties available for purchase, but can also include, without limitation, schools, businesses, parks, government facilities, hospitals, and the like. All selected real estate property and GeoPoint information can be available on demand in real-time via a network or from the GeoPoints and can be continuously or intermittently updated, for example, by other users or business owners. In other embodiments, the selected real estate property and GeoPoint information is read in whole, or in part, from a computer readable medium, such as a compact disc or digital versatile disc.

A selected real estate property or GeoPoint can be a stationary object, such as a building, business, web cam, or sensor, or it can be a moving object such as a person or vehicle. For example, the interface screen 300 can show additional pertinent information in relation to the selected property of interest 316, such as shopping, restaurants, or parking 320. In the present example, the right hand side of the interface screen 300 further displays the selected property 316 and a traffic-cam 310 directly feeding live images into the immersive environment.

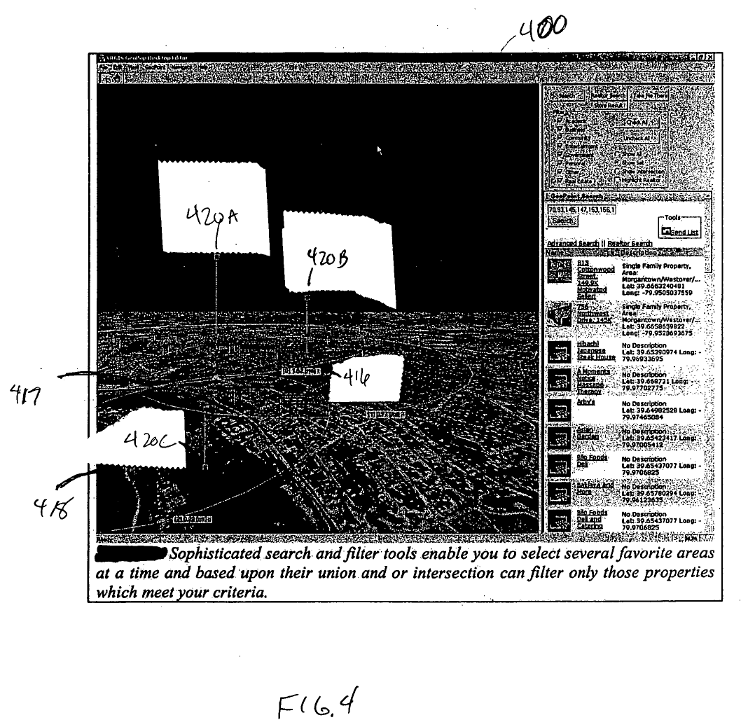

FIG. 4 illustrates one example of a 3D landscape display 400 for multiple selected properties. Supplementing traditional MLS searching and spatial displays, the 3D landscape display 400 software application provides advanced geographic information system (“GIS”) tools to filter and map locations. The illustrated 3D landscape display 400 shows three circles, each centroid determined according to user-specified location or criteria. In the present example, one location can be where a client or user wants to reside 416, the second a client workplace 417, and a third a spouse's workplace, school, or other user-designated location 418. The user can filter out the areas not within the one or more circular areas, or limit display to only the intersection of the three circles. As a union set, the circles can establish a sorting priority, adjustable by the user by “pulling” the designated markers 420A, 420B, 420C at the center of each circle to expand or reduce the area of interest.

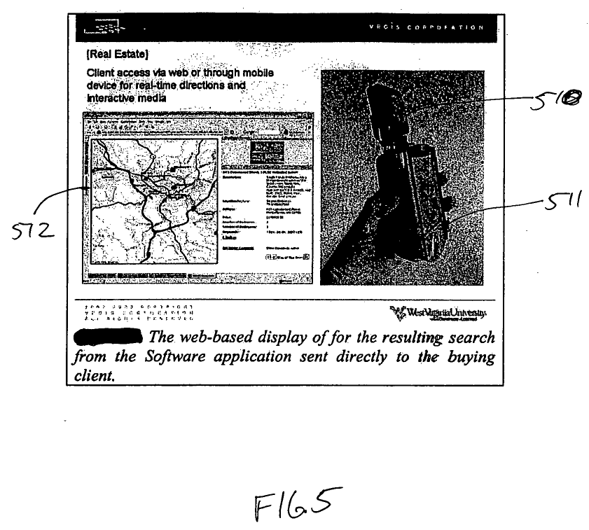

FIG. 5 is a view illustrating generally one example of a web-based geographic map display and corresponding hand-held GPS locator. This view includes one example of a web-based geographic map display 512 and corresponding commercially available hand-held GPS locator 510 operatively coupled to a personal digital assistant 511. Although a personal digital assistant 511 is illustrated, the personal digital assistant 511 can be any mobile computing device including a next generation PDA or cell phone with broadband and mapping GPS capabilities to display search related information directly on a screen of such a device or for driving directions to and from selected locations. A “Send List” function is included to provide information corresponding to a selected property or area of interest through e-mail, text message, or other message type to the client. In some embodiments, when such a message is received by a client, or other recipient, the client or other recipient is able to click, or otherwise select or copy and paste, a link provided in the message to view information about the selected property or area of interest. The other information can include directions, a 3D landscape display of the selected property or area of interest, pictures thereof, or other information pertinent to the selected property or area of interest.

The geographic map display 512 is a part of a software application that is operative on the personal digital assistant 511, or other suitable device. The software application accommodates maximum flexible robustness. In one embodiment, the shell application is encoded in C++ to take advantage of web services to populate and fill out menus, search and query toolsets and other display mechanisms. This enables a fast and efficient use of available web-based technologies and formats for images, text, audio, video, and streaming information. Datasets and other modules provided in other embodiments include user authentication, security, third party integration, and eXtensible Markup Language (“XML”) data transfer. However, other suitable programming languages, media types, and data transfer protocols and mechanisms can be used.

According to still other embodiments, the user interface can be modified to customize or enhance the overall look and feel of the application. The user interface can also be modified for specific client computing device types, such as a user interface targeted at commodity PCs with lower amounts of memory and lower processing speed rather than high end workstations with larger memories and faster processors. Other enhancements can be made to the user interface to meet specific needs of the computing environment such as improved memory management techniques employed to optimize speed for certain client computing device types, caching mechanisms. Yet further customization and enhancement can be performed to target user types, such as generating more user friendly search tools and interfaces. Other embodiments include modified user interfaces based on access rights for security purposes or subscription based purposes.

According to yet another example embodiment, a method to extrapolate multi-resolution terrain and imagery data within a small memory footprint is provided. In some locations data is available at a 6-inch resolution and can quickly become terabytes of information causing data overload for most field applications. Accordingly, data compression and extrapolation based on wavelet or other techniques can be used to compress the data to avoid data overload or to decrease system and network latency.

Yet other example embodiments provide modules to integrate MLS databases with a Client Connectivity Manager (“CCM”). Integration, for instance, can involve integrating MLS data via parsing XML into the CCM databases. In the event that web services become available to access MLS data, streamlined modules are provided to interface with 3^{rd} party web services as part of the CCM rather than data dumps via FTP and XML.

According to another example embodiment, the web services components are integrated into a C++ 3D Engine to access properties or locations of interest and subsequent MLS data that may be available via 3^{rd} party web services. In some embodiments, interfacing of the 3D engine with the enterprise system occurs by combining managed and unmanaged source code within the Microsoft .NET framework. This allows the user to interact with spatial data within a 3D environment, perform spatial queries, contextual queries, and provides a suite of user friendly 3D analytical tools based on various GIS approaches.

According to another example embodiment, a CCM provides a set of communication tools based on existing TCP and UDP protocols developed using C++ to support client/server interaction. The CCM is composed of a Communications Manager, an Administrative Manager, a User Preferences Manager, and an Accounting Manager. The Communications Manager handles network and delivery protocols, supports multi-user activity, and requests information from the database. The User Preferences Manager monitors user preferences and customizes user requests for data based on properties or locations of interest within a client awareness buffer. The Accounting and Administrative Managers track permissible user data requests and calculates accounting information based on data access. The CCM is also responsible for handling client position, client data requests from remote servers, client login authentication, data encryption when transmitting between the mobile client and the CCM server, and updates the client-side property or location of interest display. Also provided is an API for the client-side applications that can connect to the CCM server.

The CCM continuously monitors the client location and performs spatially constrained data requests to the database server. The enterprise GIS database is built, in one example embodiment, on Oracle Spatial, accessed through Arc Spatial Data Engine (“SDE”) and an object-relational geodatabase, both of which are available from ESRI of Redlands, Calif. Both spatial and multimedia data are stored as objects. Spatial search and query functions are passed from the client through the CCM to the GIS. Using the location information of the client, data for the nearest available relevant GeoPoints are retrieved from the database and routed directly to the requesting client or routed through the CCM. A GeoPoint models a point on the earth. In general, each GeoPoint is spatially recorded based on an eight degrees of freedom (“8DOF”) (latitude, longitude, altitude, pitch, roll, yaw, direction, speed) representation and this positional accuracy enables GeoPoints to be differentiated and displayed in 3D coordinate space. However, other embodiments include fewer or greater degrees of freedom representations. The database, in some embodiments, is an Oracle Spatial running on Linux Advanced Server and integrated with ArcObjects, which is also available from ESRI of Redlands, Calif. The CCM provides client access to the media object attached to the GeoPoints and stored in the Oracle database. Access to this information is performed via a database API, such as the Oracle C++ Call Interface (“OCCI”) for direct retrieval of non-GIS data. For GIS analysis, the CCM provides GeoPoint data access for GIS analysis via ArcSDE.

Thus, according to various embodiments, the present subject matter provides for the integration of real-time MLS datasets directly into the system hereof, along with high resolution 3D terrain imaging, and sophisticated GIS tools for property location. Finally, the system hereof can integrate GeoPoint technology which enables full images, text, audio, video or live streaming data from webcams, sensors and so on directly embedded into the user's desktop or mobile computer application.

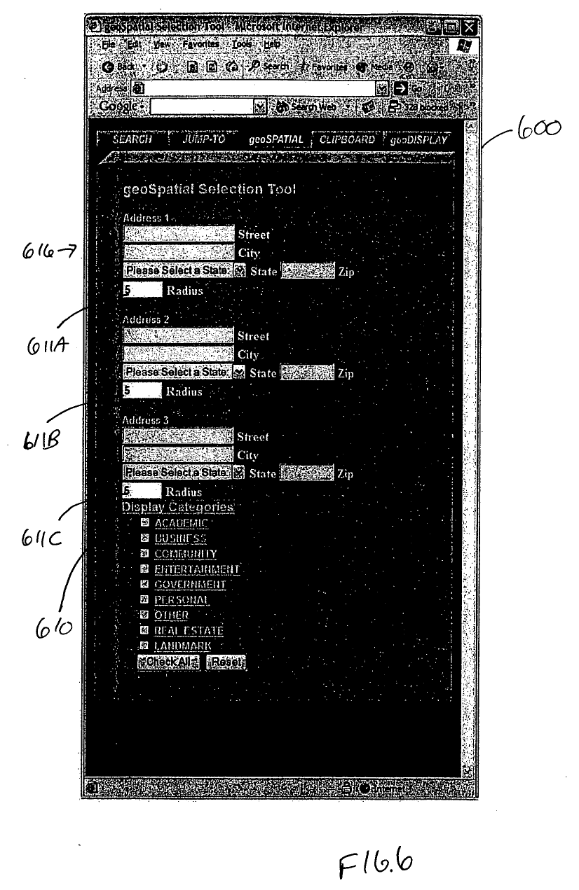

According to still additional embodiments illustrated in the user-interface screen displays of FIGS. 6-8, the present subject matter can provide high-resolution aerial imagery of major metropolitan areas, some or all of which can be color or monochromatic imagery. Various features provided include:
Visualize houses and their neighborhoods using flight simulation capability
Map house locations with full MLS property information
High-resolution aerial imagery for your real estate market
Sophisticated search, select, and display capabilities for all MLS properties
Display roads, schools, hospitals, and work-places for enhanced property searches
Email MLS information and images directly to clients for immediate impact
Calculate distances between features.
Create distance buffers around schools, day-care, and workplace to target your client's ideal property selections.

FIG. 6 is an interface screen view 600 illustrating generally one example of category tools. This view provides user-selectable address-base searching 616 and further providing additional categories 610 for display in relation to an address of interest. Information pertaining to selected display categories 610 may be limited by distance 611A-C according to user preference.

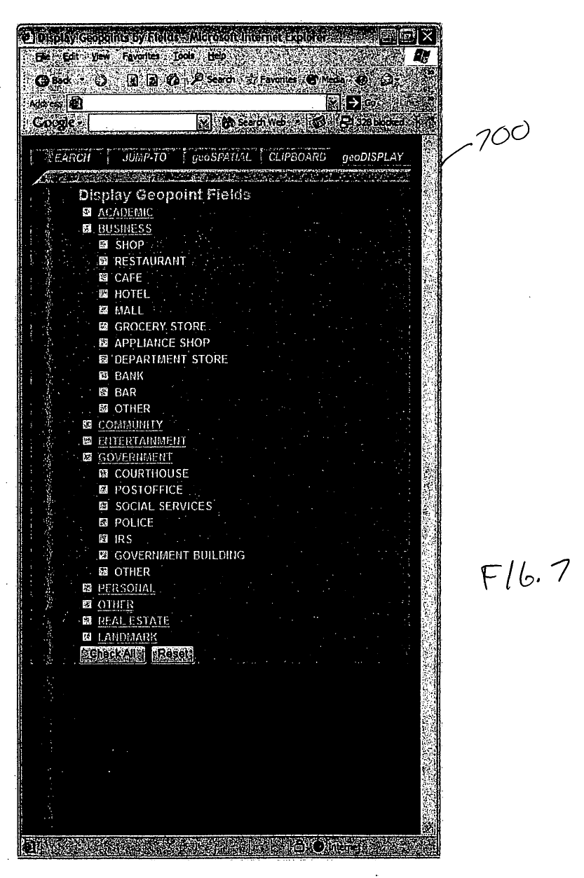

FIG. 7 is an interface screen view 700 illustrating generally one example of filtering tools. In some embodiments, selection of one or more GeoPoint fields from the interface screen view 700 causes the selected GeoPoints to be displayed to a user. In some embodiments, user-selected filtering is in relation to the address-based search request.

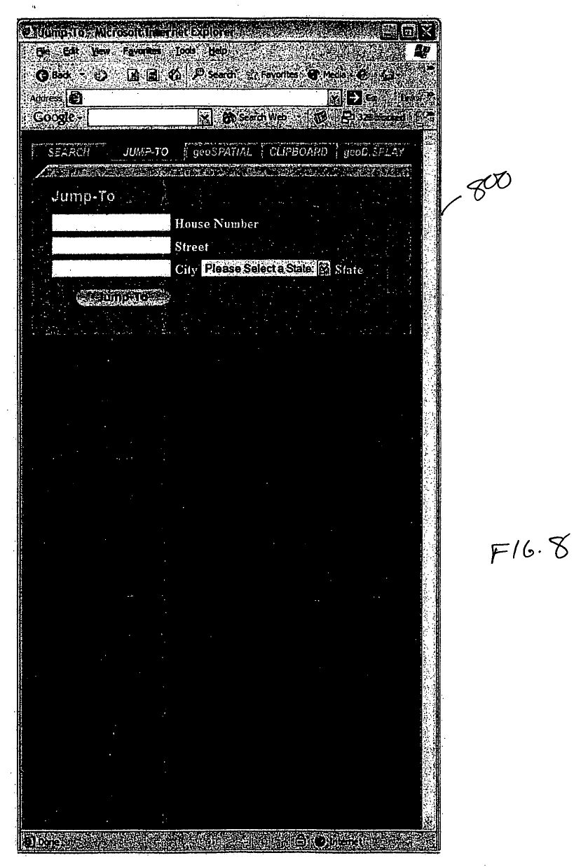

FIG. 8 is an interface screen view 800 illustrating generally one example of spatial location software tools. The user is provided a window, for example where a postal address can be used and where display of additional GeoPoint categories, such as categories 610 of FIG. 6, may not be desired or display filtering, as illustrated and described with regard to FIG. 7, may be unnecessary.

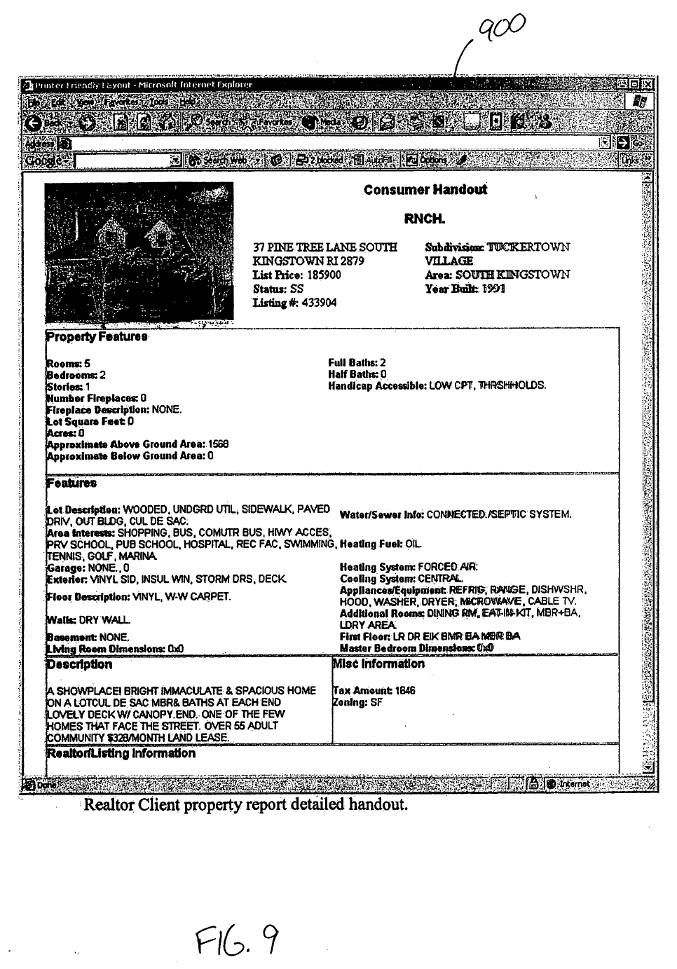

FIG. 9 is an interface screen view 900 illustrating an example of real estate property information obtained from a real estate listing service. In some embodiments, the real estate listing service is a regional Multiple Listing Service (“RMLS”). The interface screen view 900 can be retrieved from a result listing following a query, such as a user-initiated address-based search related to currently marketed real estate property.

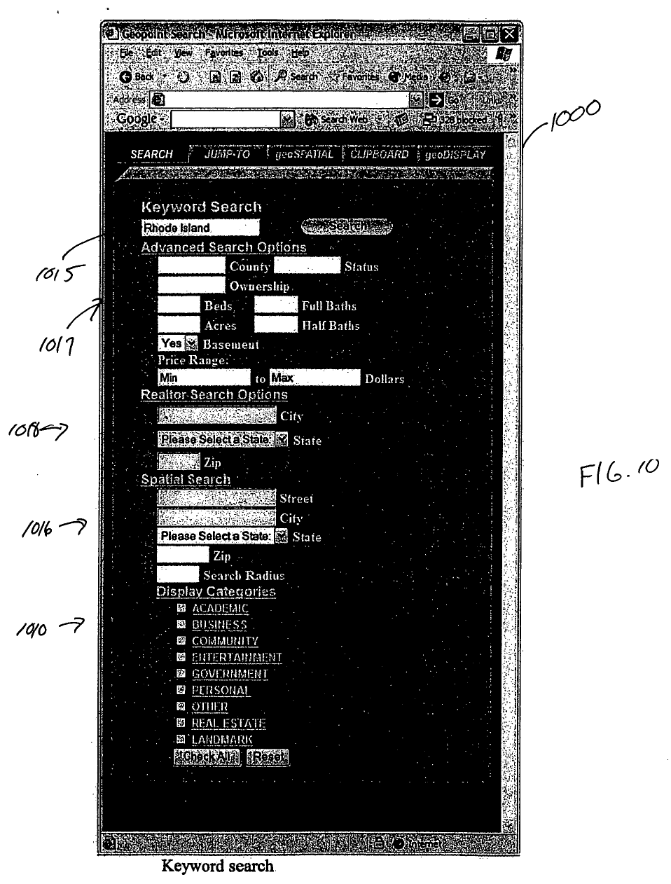

FIG. 10 is an interface screen view 1000 illustrating an example keyword search tool 1015. In some embodiments, the keyword search tool 1015 is used in relation to another search such as a spatial search 1016, for example. The interface screen provides additional categories for display 1010 in relation to the keyword search tool 1015. Additional search options such as ownership or certain real estate characteristics 1017 and general location 1018 are provided.

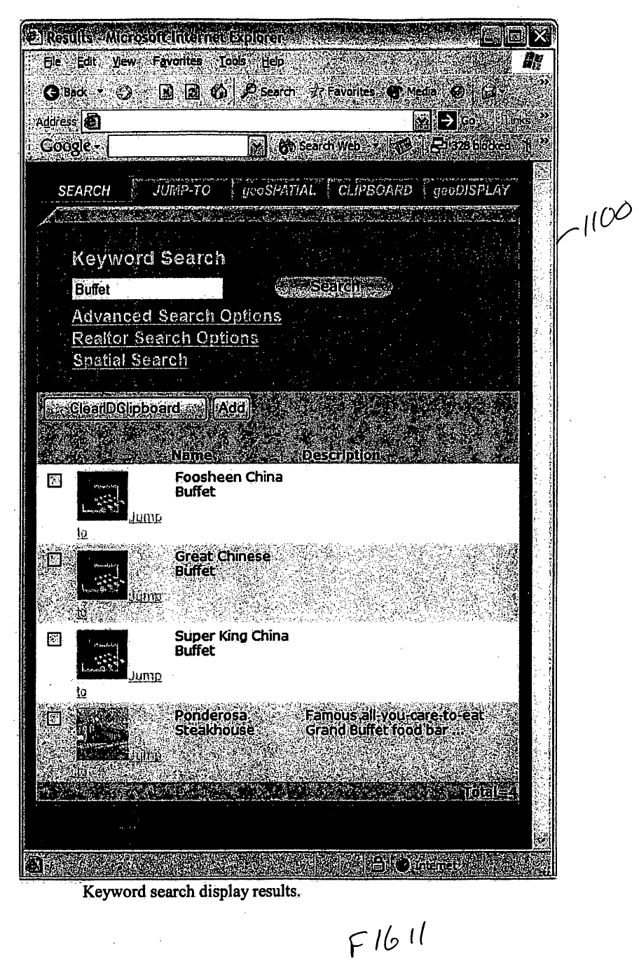

FIG. 11 illustrates a screen view 1100 of a keyword search result in view of an address. The keyword search result in other embodiments can be in view of multiple addresses. In some embodiments, other geographic locations can be used in place of the address, such as an area or a GeoPoint.

According to other embodiments, the system is connected to a national real estate listing service database to obtain current property information and provides sophisticated navigation tools to view ‘neighborhoods-at-a-glance’. Full search and select features with distance and buffer capability for enhanced property selection can be provided. Other features that are included in various embodiments include:
Full national MLS property descriptions and images.
High-resolution aerial color and/or monochromatic imagery.
Use “neighborhood-at-a-glance” to see properties in their neighborhood context.
Visualize properties and their neighborhoods using powerful over-flight capabilities.
Display road, schools, hospitals, and work-places.
Email MLS information and GeoRealtor images directly to clients.
Calculate distances between properties, day care, schools, and workplaces.
Generate distance buffers around selected schools and workplaces to maximize potential property selections.
Full search and select capabilities for MLS properties with sophisticated search by location features.
Map selected properties with accurate driving directions.
Extensive printout capabilities for MLS property information, maps, and aerial imagery.
Mouse over floating thumbnails to display MLS data.
Location enhancement capability allows user to refine property locations.
Insert and view multimedia information including photos, audio, movies, virtual tours of properties, and web links.
Integrated web capability.

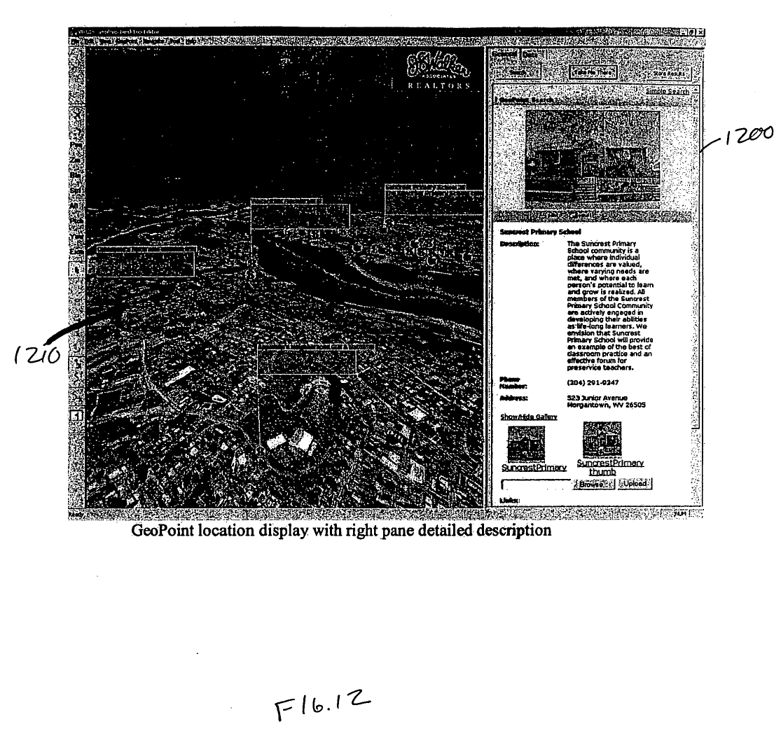

FIG. 12 illustrates an example 3D detail of a landscape view 1200 for multiple user-selected school properties. The landscape view 1200 displays landscape and terrain information 1210 in response to a search, such as an address-based search. The landscape view 1200, further displays information related to user specified categories, such as restaurants, schools, and other GeoPoints.

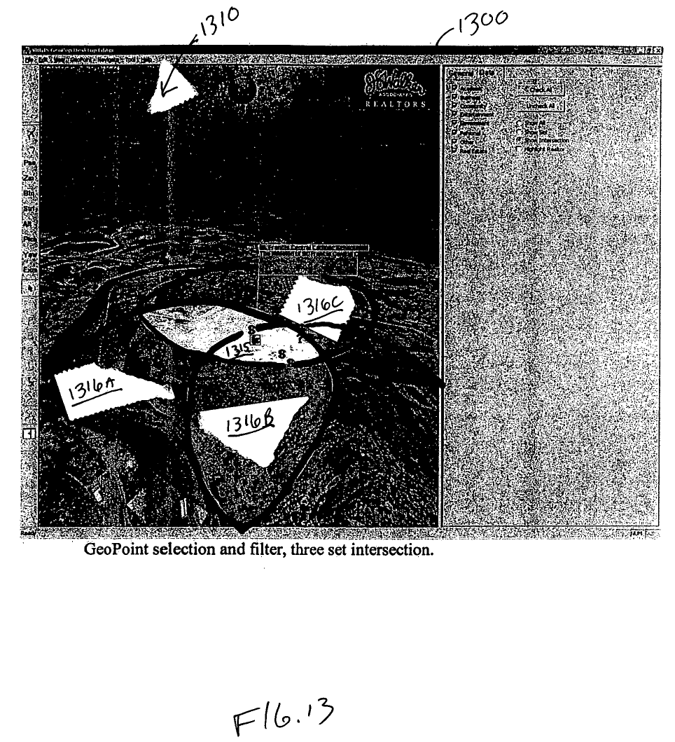

FIG. 13 illustrates one example of an interface screen 1300 displaying landscape and terrain information 1310 for the intersection of three circles 1315, each centroid 1316A-C determined according to different user-specified criteria.

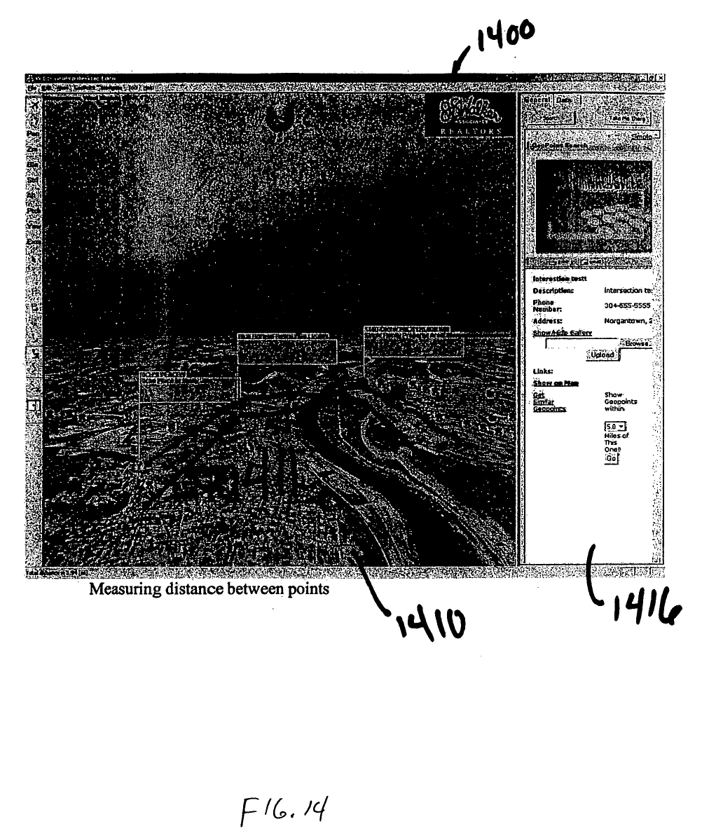

FIG. 14 illustrates one example of an interface screen 1400 displaying landscape and terrain information 1410 and optional distances 1411 between user-specified locations 1415A-C, or location determined according to user-specified criteria. The interface screen 1400 further includes a GeoPoint display options interface 1416. This interface allows a user to cause user specified GeoPoints to be identified within landscape and terrain information 1410.

In various embodiments, the interfaces are provided to users on platforms including Microsoft Windows, Linux, Mac O/S, Unix, Palm O/S, and other platform operating systems. In some embodiments, the interface is provided in a web browser such as Microsoft Internet Explorer, Netscape Navigator, Fire Fox, OpenWave, or other web browser.

### GeoPoint System Architecture

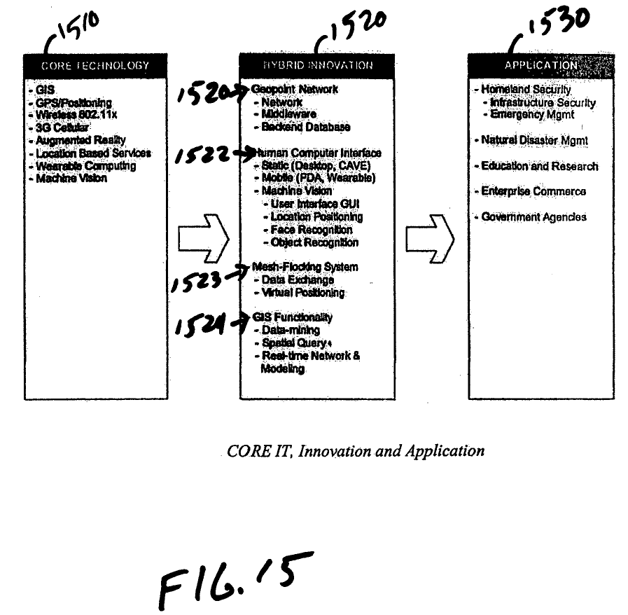

FIG. 15 illustrates one example embodiment of a system on which the subject matter hereof can be practiced. This system delivers real-time information in an Enhanced location based service (“LBS”) environment that is intelligent and spatialized via a network of GeoPoints virtually embedded within the physical fabric of the real world. This enhanced environment 1510 can include one or more elements from such systems as GIS (Burrough & McDonnell, 1998; Chrisman, 2001; Clarke, 2002; DeMers, 1999; Longley et al., 1999), GPS (Kennedy, 1996; Trimble, 2002), LBS (LBSZone, 2002; 3gLocate.com, 2003; VanderMeer, 2002), wireless (Sprint, Inc., 2003; Shen, 2003), machine vision (BMVA, 2002; Machine Vision Group, 2003), and AR (Azma, 1997; Julier, 2000; Piekarski et al., 1999; Thwaites & Addison, 2201; Fisher & Unwin, 2002). (It is noted for the avoidance of doubt that none of the foregoing systems/publications or ones enumerated below are admitted to be prior art to the present application solely as a result of being listed herein.) According to one embodiment, these applications 1520 are grouped into modules, 1) GeoPoints Network 1521, 2) Human Computer Interface 1522, 3) Mesh-Flocking System 1523, and 4) GIS Functionality 1524. The modules have extended application 1530 for Homeland Security, natural disaster management, education and research, enterprise commerce, and for government agencies, among other application.

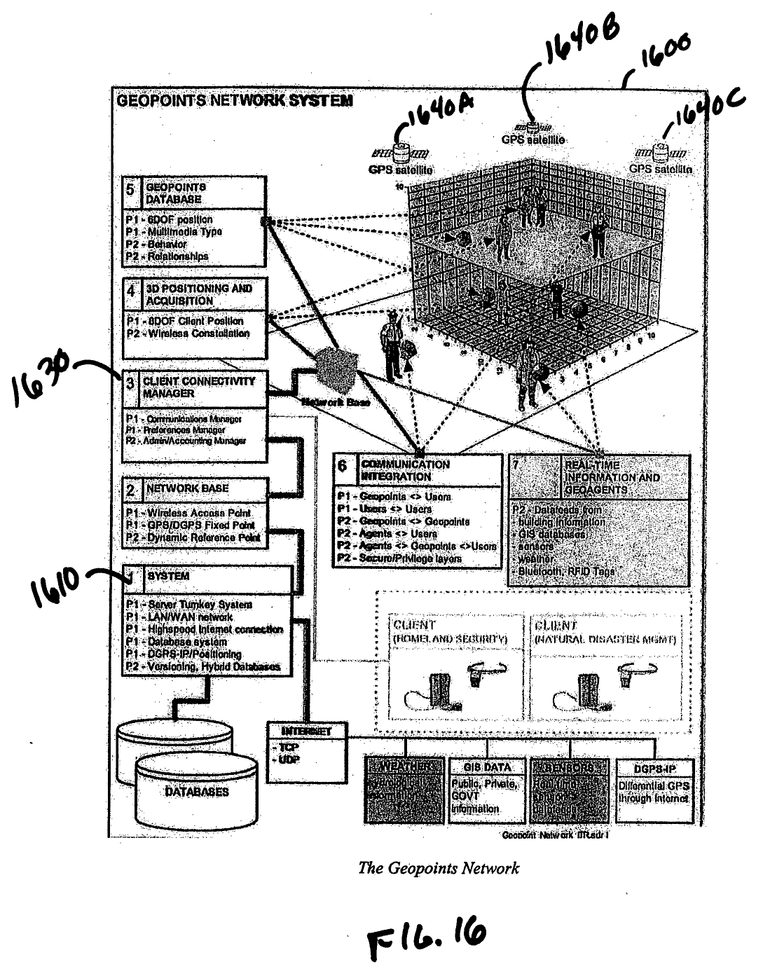

FIG. 16 illustrates one example embodiment the present subject matter. GeoPoints are loosely based on traditional GPS waypoints obtained from GPS satellites 1640A-C, possessing latitude, longitude, altitude and metadata information for point-of-interest wayfinding markers. In addition, GeoPoints, in some embodiments, also have attributes enabling them to deliver location, spatial orientation (pitch, roll, yaw), behavior, and temporal-relationship information utilized by other GeoPoints, agents and users. GeoPoints are media rich and intelligent, and consist of raw data, multimedia, audio, video streams, text, sensor data, or any other digital information. Through positional and behavioral metadata, a GeoPoint becomes an enhanced LBS mediapoint that has a direct relationship to its physical location, as well as to other users and agents. The virtual Geopoint is viewed using an Augmented Reality (“AR”) client and a wearable computing system. A Geopoint Network can empower users to detach themselves from the desktop computer and dynamically move through a real world environment, interacting with GeoPoints and other users who are also seamlessly integrated into personal tasks and their own environments.

In another example embodiment, the system includes a connectivity manager and database server cluster responsible for data storage access, retrieval and complex data mining. The desktop, immersive, and mobile clients are connected via a high-speed network, such as a wired or wireless network, to the Internet. While the server network cluster is based on Standardized Commercial Off the Shelf (SCOTS) equipment, the client platforms, in various embodiments, are custom hardware and software configured specifically to targeted applications and include technologies such as Organic Light Emitting Diodes (OLED) display headsets, hybrid positioning systems, mesh technologies, and wearable computing devices (Wave Report, 2001; Kodak, Inc., 2003). The network is designed to provide several key functions to increase data management and flow and enhanced positioning information. Extended enhancements, according to another embodiment, include a versioning database for non-destructive editing of information, archiving, and media streaming. The network module can include LAN/WAN connections to wireless network access points for data delivery and manage the integrated GPS, Differential GPS (DGPS), and DGPS-IP positional information to increase the accuracy of positional information delivery (Rupprecht, 2002).

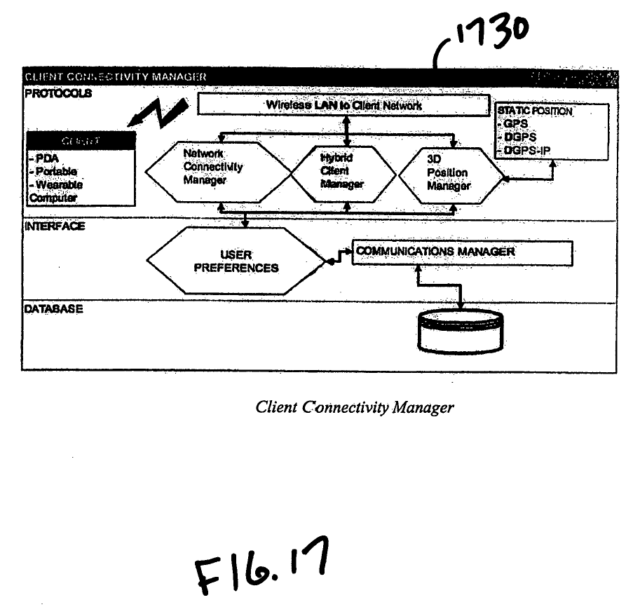

FIG. 17 is schematic illustrating generally Client Connectivity Manager (“CCM”) 1730. The CCM serves as the communication hub between mobile users and relevant GeoPoint data. The CCM monitors a mobile client position by continuously receiving the client's GPS-based location and accessing the GIS database to retrieve the relevant data. The CCM automatically retrieves GeoPoint data for each user and provides information corresponding to the prescribed users' preferences and enforces client data access privileges.

GPS and DGPS signal streams based on RCTM IN NMEA OUT strings are obtained using a GPS receiver board embedded into each clients' wearable, or otherwise mobile, computing device. The positional accuracy of the client device is increased though the use of Assisted GPS technologies (Djuknic and Richton, 2002). Differential signals are broadcast through the Internet TCP protocols using a Differential Internet GPS technology called DGPS-IP (Rupprecht, 2002). By implementing this system and using the 802.11x wireless system for trilateration positioning, accuracy approaching and surpassing sub-meter positional accuracy becomes possible. As users traverse a physical environment, their location is relayed to the CCM, which responds by transmitting GeoPoint data retrieved from the GIS database. The GIS serves the GeoPoints to the clients and provides a mechanism to store and retrieve associated GeoPoint data such as imagery, video, audio, text, blueprints, and floor plans, and performs complex analysis (Câmara and Raper, 1999). The GIS functionality allows users to access available current data, historical and time-critical data, and also undertake what-if simulations and event modeling. The real-time connectivity allows a user to have a persistent connection to all new data, events and other information being updated in the system in real-time. Thus if the situation changes in one part of the network then other users across the entire network are also immediately undated.

The delivery of ‘just-in-time’ knowledge through an assistive and adaptive client holds considerable potential for improved decision-making, management and improved communication and data flow. The GeoPoint Network client, in one embodiment, is a custom application written for 2D and 3D static and mobile devices. Static devices include desktop and immersive virtual reality clients (both Headset and CAVE like environments). Mobile devices include Personal Digital Assistants (PDAs), and portable and custom wearable computing systems. The devices use positioning systems including E911 cellular technologies (Eichelberger, 2002; Yoshida, 1999), GPS, Assisted GPS, DGPS-IP and sensing technologies including accelerometers and magnetometers. Network connectivity is managed through a hybrid mix of 802.11x, LAN, and cellular 3G services. A custom peripheral can also be provided to manage and monitor network connections and supply the user with a consistent, best-available, “Quality of Service”. Machine Vision is used by the client to provide positional information, virtual user interfaces such as a gesture mouse and virtual keyboard, along with face recognition and tracking, and object recognition.

Building upon emerging Mesh Network technologies, according to one example embodiment, the system of the present subject matter creates a Mesh-Flocking system. By using ad-hoc mesh network data sharing, mobile users query a spatially close ‘knowledge neighbor’ for information relevant to their current query. This expedites and enhances the use of GeoPoint information by applying the local knowledge of an environment from other ‘experienced’ users to new users, thereby obviating the need for querying the remote database each time a request is made for data (Mobile Mesh, 2000; SearchNetworking.com, 2003).

In addition, each client receives GPS and sensing positioning information from the other nearby users to form a dynamic Flocking Constellation system. This system is an integration of artificial life ‘Flocking’ (Dolan, 2003; Reynolds, 2001), sensor technologies, and GPS. In the event that the GPS satellites become unavailable, clients can compute a synthetic position by combining trilateration techniques to the wireless infrastructure formed by the 802.11x ‘ad-hoc’ network among clients within the allowed range of wireless technologies.

In yet another embodiment, requests for GeoPoint data are parsed through the CCM to the enterprise GIS. The data query and search is optimized based on the client's location information and data is cached in readiness for client calls. The GIS database is based on Oracle Spatial and spatial information is retrieved using ESRI's Arc Spatial Data Engine (“ArcSDE”). Calls to the database for multimedia information are made using Oracle C++ Call Interface (“OCCI”), or other database API relevant to the particular embodiment. A comprehensive range of geographical and multimedia information can thus be made available to the client, along with the ability for users to establish their own GeoPoints and populate them with personal information. GIS functionality extends beyond data search and retrieval to include simulation and modeling capability (Raper, 2000). Thus requests to identify an optimal route from one GeoPoint to the next can be made to the GIS and a network route returned to the nearest GeoPoint. The exploitation of complex data mining between heterogeneous databases and real-time event modeling and simulation can draw heavily upon the advanced functionality of the GIS (Chrisman, 2001; Clarke, 2002; DeMers, 1999; Longley et al., 1999; Zeiler, 1999).

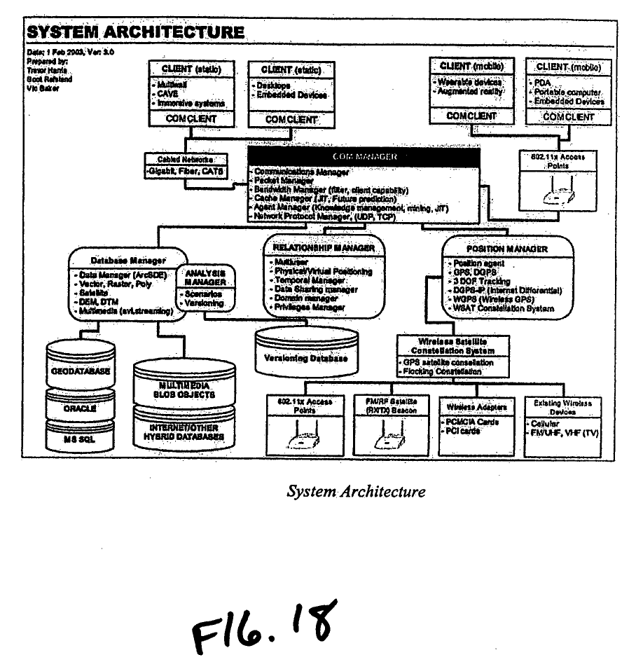

FIG. 18 is schematic illustrating a GeoPoint system architecture according to an embodiment. In this embodiment there is provided a hosting network for position acquisition, managing user requests, and serving GeoPoint data and media objects from the database server. The backend cluster network infrastructure is built, for example, on Gigabit connectivity, an Oracle Spatial database server, the Client Connectivity Manager server and a DGPS-IP positioning server. Mobile clients access the network through Wireless Access Points and 3G Cellular.

According to another example embodiment, a set of communication tools based on existing TCP and UDP protocols are provided and developed from C++ to support client/server interaction. The CCM is composed of a Communications Manager, an Administrative Manager, and a User Preferences Manager. The Communications Manager handles network and delivery protocols, supports multi-user activity, and request information from the database. The User Preferences Manager monitors user preferences and customizes user requests for data based on GeoPoints within the Client's awareness buffer. The Administrative Manager tracks permissible user data requests. The CCM is also responsible for handling client position, client data requests from remote servers, client login authentication, data encryption when transmitting between the mobile client and the CCM server, and updates the client-side GeoPoint display. Some embodiments further include an API for the client-side applications that provides client side applications connectivity to the CCM server.

The CCM continuously monitors the client location and performs spatially targeted constrained data requests to the database server. The enterprise GIS database is built on Oracle Spatial, accessed though ArcSDE and ESRI's object-relational Geodatabase (Zeiler, 1999). Both spatial and multimedia data are stored as objects. Spatial search and query functions are passed from the client through the CCM to the GIS. Using the location information of the client, data for the nearest available relevant GeoPoints are retrieved from the database and routed directly to the requesting client or routed through the CCM. Each GeoPoint is spatially recorded based on 8DOF (latitude, longitude, altitude, pitch, roll, yaw, direction, speed) and this positional accuracy enables GeoPoints to be differentiated and displayed in 3D coordinate space. The database is, according to one example embodiment, an Oracle Spatial running on Linux Advanced Server and linked to ESRI's ArcObjects (ESRI, 1999). The CCM provides client access to the media object attached to the GeoPoints and stored in the Oracle database. Access to this information is performed via OCCI database API for direct retrieval of non-GIS data. For GIS analysis, the CCM provides GeoPoint data access for GIS analysis via ArcSDE.

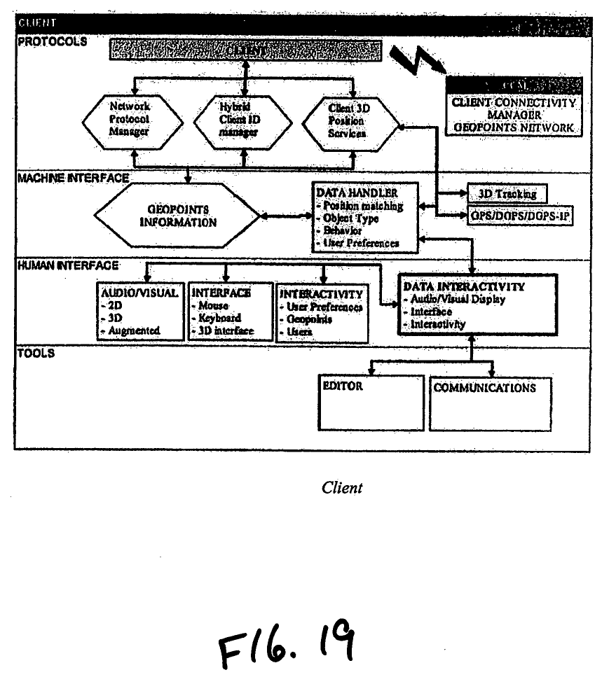

The complete mobile application combines accurate positioning, augmented reality, wireless networking, speech recognition, and machine vision modules (FIG. 19). Users will, in one embodiment, experience the GeoPoint Network via a 3D augmented reality capable of displaying 3D objects overlaid on the physical environment and delivered through a next generation OLED augmented vision transparent headset or by using a mobile client screen as a virtual window. The mobile client application provides user interaction with the GeoPoints and other users and is responsible for establishing a network connection with the database via the CCM through which the Client's position is sent and relevant GeoPoint data is returned. Peer-to-Peer communication is also enhanced through audio, video, and text messaging services.

The mobile client user interface is achieved, in one embodiment, via machine vision, speech recognition, and speech synthesis. A ‘Gesture Mouse’ provides selection, modification, add, and delete capability through hand gestures (Machine Vision Group, 2003; Shamaie and Sutherland, 2001). Speech recognition and speech synthesis complement the Gesture Mouse with a vocal command capability as well as the ability to receive auditory feedback from the mobile client.

Accurate outdoor positioning is achieved through a combination of GPS, Differential GPS, and DGPS-IP. Indoor positioning is accomplished by computing an offset from a known location using a combination of magnetometers, gyroscopes, accelerometers, and Wireless Access Point trilateration. Both indoor and outdoor services are augmented using the Assisted GPS and the Mesh-Flock technology integrated with custom inertia position sensors for greater 8DOF accuracy.

According to one embodiment, a mobile client is provided for the Windows XP operating system running on a laptop computer equipped with a 3D accelerator graphics chip. In some embodiments, the mobile client is developed primarily in Java and Java 3D with some subcomponents developed in C with a JNI wrapper. Components are, in one embodiment, implemented in C and C++ to improve runtime performance. In order to utilize the advanced computing power of handheld devices, mobile client development can include a 2D planar version of the mobile client application to provide speech recognition, spatialized audio, and synthesized speech. In some embodiments, using the Pocket PC handheld platform, 3D graphic and augmented reality are delivered by a headset connected to a PocketPC or other similar personal digital assistant, mobile phone, or other mobile computing device. Such devices can enable sight-impaired users to use auditory GeoPoints as a tool of wayfinding and information retrieval.

The use of machine vision can augment the client application through an adaptive interface. A Gesture Mouse user interface recognizes hand gestures for performing advanced interaction tasks with the GeoPoints Network. The Gesture Mouse system is heuristic and adaptive and adjusts to the user's interaction style to minimize user learning and utilization. In addition the Gesture Mouse is capable of distinguishing the user's hand from background noise to minimize erroneous tracking. Advanced uses of the machine vision module include multiple face recognition and tracking, and text, object and environment recognition.

An immersive desktop version of the GeoPoint Editor provides interactive tools for creating and editing GeoPoints as well as complex environment building tools for the GeoPoint Network. The GeoPoint Editor provides a panoptic view of the overall environment and enables a user to create, modify, and delete GeoPoints, simulations and schemas by interacting with the virtual space. The GeoPoint Editor user is also able to manage and monitor mobile clients, interact directly with users through various communication tools, and provide advanced system administration functions. The editor is a module of the command console featuring extended GIS and management functionality for custom, mission-critical applications.

By linking to user-interface modules such as the Gesture Mouse, speech recognition, and speech synthesis; the Geopoint Editor enables users to freely interact with the Geopoint Network in virtual space through the immersive technology of a CAVE-style MultiWall (WVEL, 2003) virtual reality system developed at West Virginia University. The MultiWall virtual reality system is composed of an immersive wrap-around display provided by an 8′ rear-projected cube within which the user stands and interacts with the 3D virtual objects. Motion-tracking monitors user head location for proper perspective rendering and a module incorporate the Gesture Mouse to create, modify, and delete GeoPoints and drive the user interface. In some embodiments, the mobile client includes a scaled-down version of this editor for in-the-field interaction and control.

According to another example embodiment, a Flocking Constellation of mobile clients share network bandwidth and data, and act as a constellation of synthetic positional satellites to compute position based on telemetry. To achieve a shared, distributed mobile network, clients join ad-hoc networks of spatially close mobile clients via ad-hoc wireless networks to enable the sharing of network bandwidth and data. When a user requests information regarding a specific GeoPoint, the mobile client polls the other mobile clients in the ad-hoc network using in a ‘Go Fish’ scenario. If another user in the ad-hoc network has the relevant file, then it can be transferred to the requesting party via the same ad-hoc network. If no other user in the party has the requested data, then the clients can spawn multiple requests through a 3G Cellular network, or other suitable network type, to download portions of the data from a remote server. These downloaded segments are then combined locally by the requesting client and shared with other clients via the ad-hoc wireless network. In this way scarce client-server bandwidth is maximized.

Similarly, when a client seeks to upload GeoPoint information to the remote server, bandwidth is maximized by segmenting the data file into smaller portions that are dispersed to other users in the ad-hoc wireless network. These network members can then upload the data to the remote server through the 3G Cellular network where the segments are reassembled into a single file by the CCM. In this way the system reduces network transmission time.

The Flocking Constellation also provides a mechanism for establishing client position when the client is part of an ad-hoc network. As mobile clients traverse the physical environment, they act as ‘pseudo-satellites’ (synthetic GPS satellites) and transmit a GPS NMEA string to other mobile clients in the same ad-hoc network. The synthesized NMEA string is used to enhance a client's positional information as measured by GPS or other location sensors. The NMEA strings are then transmitted via the ad-hoc wireless network to the client and positions are established. If the GPS signal to a client is interrupted, other mobile clients can either continue to act as an ad-hoc network by receiving and transmitting their own positional information to the off-line client or may adjust their last known position based upon movement sensors.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A system comprising:
a database of data representing three-dimensional topographic views of geographic areas;
a computer system adapted to present a topographic view of a geographic area based on a query by a user for information related to a listing of a property for sale or lease.

2. The system of claim 1, wherein the database of data representing three-dimensional topographic views of geographic areas includes aerial photographic data that is displayable on the computer system along with the topographic view.

3. The system of claim 1, wherein information related to a listing of a property for sale or lease is retrieved by the computer system from a real estate listing service database.

4. The system of claim 1, wherein the computer system is a mobile computing device.

5. The system of claim 4, wherein the mobile computing device includes a global-positioning data receiving device.

6. The system of claim 4, wherein the mobile computing device is a personal digital assistant.

7. A system comprising:
a three-dimensional terrain module;
an imaging module;
a mapping module;
a property listing module; and
a display module, wherein the display module generates visual display output data including data from one or more of the three-dimensional terrain module, the imaging module, the mapping module, and the property listing module.

8. The system of claim 7, wherein the display module transmits the visual display output data over a network in response to a request for the visual output data.

9. The system of claim 7, wherein the visual display output data is viewable in a software application capable of functioning at least in part as a web browser.

10. The system of claim 7, further comprising:
a feature module, wherein the feature module provides access to data from features including GeoPoints, businesses, schools, parks, government entities, and other features of interest to parties involved in a real estate search.

11. The system of claim 10, further comprising:
a search module, wherein the search module searches data including data available from the property listing module, the mapping module, and the feature module based on received search criteria.

12. The system of claim 11, wherein output from the search module in response to received search criteria includes search result identifiers plotted with in the visual display output of the display module.

13. A method comprising:
receiving real estate listing search criteria;
searching a real estate listing database for available properties based on the received real estate listing criteria;
receiving a number of available properties from the searching; and
plotting the available properties in a three-dimensional topographic view.

14. The method of claim 13, wherein receiving real estate listing search criteria includes:
receiving two or more search locations and a radius of interest from each;
identifying a union area of the two or more search areas;
searching the real estate listing database for available properties within the union area; and
plotting the available properties in the three-dimensional topographic view, wherein the three-dimensional view is of an area including the union area.

15. The method of claim 13, wherein the search criteria includes text search criteria.

16. The method of claim 13, further comprising:
receiving feature category filtering input, wherein the feature category filtering input identifies categories of features to display; and
searching a feature database to identify features to plot in the three-dimensional topographic view; and
plotting the identified features in the three-dimensional topographic view.

17. The method of claim 16, wherein the feature category filtering input identifies one or more of academic facilities, businesses, entertainment facilities, landmarks, and government facilities.

18. The method of claim 17, further comprising:
measuring distances between plotted available properties and plotted identified features;
plotting in the three-dimensional topographic view, the measured distances.

19. The method of claim 13, wherein plotting the available properties in a three-dimensional topographic view includes displaying for an available property an image of the respective property floating in the three-dimensional topographic view above the property.

20. The method of claim 13, wherein the three-dimensional topographic view is an interactive view allowing a user to move throughout the three-dimensional topographic view.
